(19) United States
(12) Patent Application Publication
(10) Pub. No.: US 2012/0320712 A1
(43) Pub. Date: Dec. 20, 2012

(54) DIP SEISMIC ATTRIBUTE

(76) Inventors: Ahmed Adnan Aqrawi, Stavanger (NO); Trond Hellem Bø, Randaberg (NO)

(21) Appl. No.: 13/494,842

(22) Filed: Jun. 12, 2012

Related U.S. Application Data
(60) Provisional application No. 61/498,773, filed on Jun. 20, 2011.

(51) Int. Cl. G01V 1/36

(52) U.S. Cl. 367/53

(57) ABSTRACT

A method can include, within a neighborhood, selecting a sample seismic trace and neighboring seismic traces, individually time shifting each of the neighboring seismic traces with respect to the sample seismic trace to determine a set of individual time shift values that correspond to individual maximum cross correlation values for each of the neighboring seismic traces with respect to the sample seismic trace, determining series of inline direction and crossline direction first derivative values for the set of time shift values, determining an inline average dip value and a crossline average dip value based on the series of first derivative values, and storing to a memory storage device, coordinates for the sample seismic trace, the inline average dip value, and the crossline average dip value. Various other apparatuses, systems, methods, etc., are also disclosed.

### RELATED APPLICATIONS

This application claims the benefit of a U.S. provisional application having Ser. No. 61/498,773, entitled “Direction Dip Seismic Attribute”, filed Jun. 20, 2011, which is incorporated by reference herein in its entirety.

### BACKGROUND

Seismic interpretation is a process that may examine seismic data (e.g., with respect to location and time or depth) in an effort to identify subsurface structures (e.g., horizons, faults, geobodies, etc.). Structures may be, for example, stratigraphic formations indicative of hydrocarbon traps or flow channels. In the field of resource extraction, enhancements to seismic interpretation can increase accuracy of a model of a geologic environment, which, in turn, may improve seismic volume analysis for purposes of resource extraction. Various techniques described herein pertain to processing of seismic data, for example, for analysis of such data (e.g., for identifying structures in a geologic environment).

### SUMMARY

A method can include, within a neighborhood, selecting a sample seismic trace and neighboring seismic traces, individually time shifting each of the neighboring seismic traces with respect to the sample seismic trace to determine a set of individual time shift values that correspond to individual maximum cross correlation values for each of the neighboring seismic traces with respect to the sample seismic trace, determining series of inline direction and crossline direction first derivative values for the set of time shift values, and determining an inline average dip value and a crossline average dip value based on the series of first derivative values. A system can include one or more processors; memory; and instructions stored in the memory and executable by at least one of the one or more processors to access seismic traces, determine time shift values for pairs of the seismic traces (e.g., where a time shift value for a pair of seismic traces corresponds to a maximum cross correlation value for the pair), process the time shift values to provide dip angle values, and, for example, render to a display an image based at least in part on the dip angle values. One or more computer-readable storage media can include computer-executable instructions to instruct a computing device to: access weighted average inline dip angle values and weighted average crossline dip angle values; select an algorithm from a group of algorithms that includes a directional dip algorithm and a dip magnitude algorithm; and apply the selected algorithm to the weighted average inline dip angle values and the weighted average crossline dip angle values to generate image data. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for simulating a geological environment;

FIG. 2 illustrates examples of azimuth and dip angle, data acquisition, a system and geometrical attributes;

FIG. 3 illustrates an example of a method for a dip attribute;

FIG. 4 shows an example of a coherence approach to determining dip angle;

FIG. 5 illustrates an example of a time shift method for use in determining dip angle;

FIG. 6 illustrates an example of a method that includes time shifting individual traces;

FIG. 7 illustrates an example of a method for use in determining dip angle;

FIG. 8 illustrates an example of a method for determining an average inline dip angle and an average crossline dip angle;

FIG. 9 illustrates an example of a method for processing dip angle information and rendering one or more images;

FIG. 10 illustrates examples of images;

FIG. 11 illustrates examples of images;

FIG. 12 illustrates examples of images;

FIG. 13 illustrates an example of a method that can include approximating dip prior to applying a time shift method; and

FIG. 14 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

Seismic interpretation is a process that involves examining seismic data (e.g., with respect to location and time or depth) to identify one or more types of subsurface structures (e.g., horizons, faults, geobodies, etc.). When performing seismic interpretation, seismic data may be provided in the form of traces where, for example, each trace is an amplitude versus time recording of energy emitted by a source that has interacted with various subsurface structures. An interpretation process may involve visual display of seismic data and interaction using one or more tools (e.g., executable instruction modules stored in memory and executed by one or more processors). An interpretation process may consider vertical seismic sections, inline and crossline directions, horizontal seismic sections called horizontal time slices, etc. Seismic data may optionally be interpreted with other data such as, for example, well log data.

As an example, an interpretation process may include accessing seismic data from a data store (e.g., via a network or other connection). Seismic data may be formatted according to one of the SEG-Y format standards (Society of Exploration Geophysicists), the ZGY format standard (e.g., a bricked format) or another format. As an example, seismic data may be stored with trace header information, which may assist in analysis of the seismic data. Seismic data may optionally be accessed, for example, according to a number of traces (e.g., in an inline, crossline or inline and crossline directions), which may be entire traces or portions thereof (e.g., for one or more particular times or depths). As an example, given a number of traces across a region, a process may access some of those traces in a sub-region by specifying inline and crossline indexes (e.g., or geographic or grid coordinates) as well as a time or depth window.

An interpretation process may include determining one or more seismic attributes. A seismic attribute may be considered, for example, a way to describe, quantify, etc., characteristic content of seismic data. As an example, a quantified characteristic may be computed, measured, etc., from seismic data. A seismic attribute may be a rate of change of a quantity (or quantities) with respect to time, space or both time and space. As an example, a seismic attribute may provide for examination of seismic data in an amplitude domain, in a time domain, or in another manner. As an example, a seismic attribute may be based on another seismic attribute (e.g., a second derivative seismic attribute may be based on a first derivative seismic attribute, etc.).

An interpretation framework may include modules (e.g., processor-executable instructions stored in memory) to determine one or more seismic attributes. Seismic attributes may optionally be classified, for example, as volume attributes or surface attributes. As an example, a volume attribute may be an attribute computed from a seismic cube and may result in a new seismic cube that includes information pertaining to the volume attribute. As an example, a surface attribute may be a value associated with a surface of a seismic cube that includes information pertaining to a volume attribute.

A seismic interpretation may be performed using displayable information, for example, by rendering information to a display device, a projection device, a printing device, etc. As an example, one or more color schemes (e.g., optionally including black and white or greyscale) may be referenced for displayable information to enhance visual examination of the displayable information. A color scheme may include a palette, a range, etc. A look-up-table (LUT) or other data structure, function (e.g., linear or non-linear), etc., may allow for mapping of values associated with one or more seismic attributes to intensity, colors (e.g., RGB, YCbCr, etc.), etc. Where the human eye will be used or is used for viewing displayable information, a display scheme may be selected to enhance interpretation (e.g., to increase contrast, provide for blinking, etc.).

A module for determining one or more seismic attributes may include one or more parameters. As an example, a module may include one or more parameters that may be set via a graphic user interface, a specification file, etc. In such an example, an interpreter may wish to examine a seismic attribute for seismic data using one or more values of a parameter. As an example, such a module may provide a default value and a field, graphical control, etc., that allows for input of a value other than the default value.

As an example, seismic interpretation may be performed using seismic to simulation software such as the PETREL® seismic to simulation software framework (Schlumberger Limited, Houston, Tex.), which includes various features to perform attribute analyses (e.g., with respect to a 3D seismic cube, a 2D seismic line, etc.). While the PETREL® seismic to simulation software framework is mentioned, other types of software, frameworks, etc., may be employed for purposes of attribute analyses.

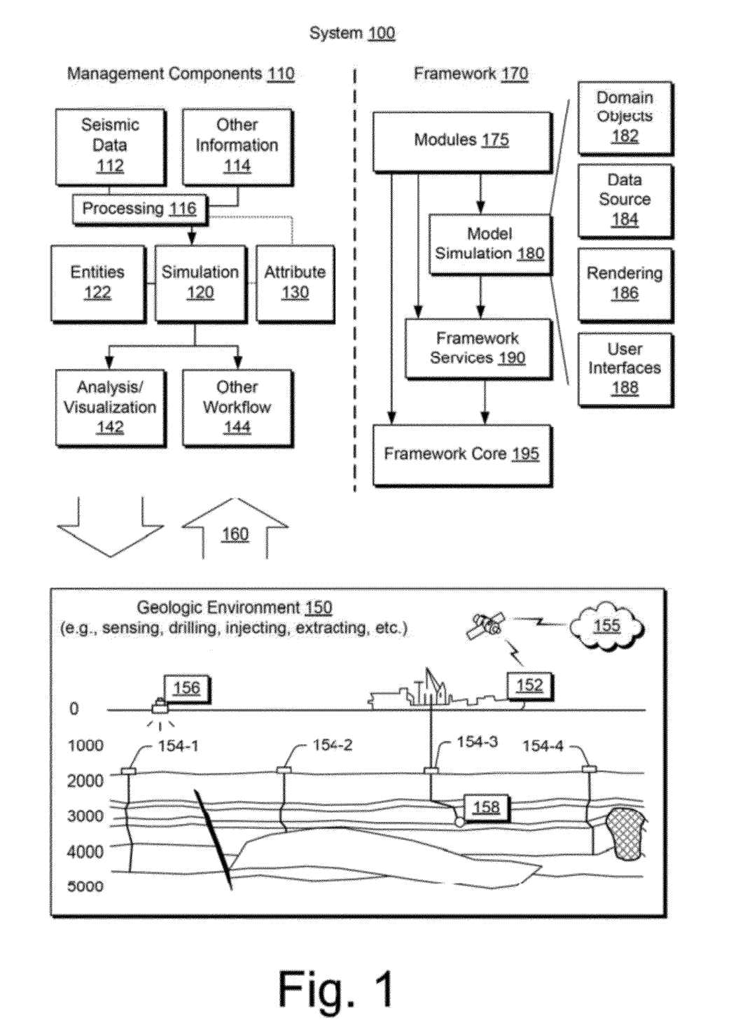

FIG. 1 shows an example of a system 100 that includes various management components 110 to manage various aspects of a geologic environment 150 (e.g., an environment that includes a sedimentary basin) as well as an example of a framework 170. In the example of FIG. 1, the components may be or include one or more modules. As to the management components 110, one or more of these components may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, reservoirs, geobodies, etc. In the system 100, the entities 122 can include virtual representations of actual physical entities that are reconstructed for purposes of simulation. The entities 122 may include entities based on data acquired via sensing, observation, interpretation, etc. (e.g., the seismic data 112 and other information 114).

In an example embodiment, the simulation component 120 may rely on a software framework such as an object-based framework. In such a framework, entities may include entities based on pre-defined classes to facilitate modeling and simulation. A commercially available example of an object-based framework is the MICROSOFT®.NET™ framework (Redmond, Wash.), which provides a set of extensible object classes. In the .NET™ framework, an object class encapsulates a module of reusable code and associated data structures. Object classes can be used to instantiate object instances for use in by a program, script, etc. For example, borehole classes may define objects for representing boreholes based on well data, geobody classes may define objects for representing geobodies based on seismic data, etc. As an example, an interpretation process that includes generation of one or more seismic attributes may provide for definition of a geobody using one or more classes. Such a process may occur via user input (e.g., user interaction), semi-automatically or automatically (e.g., via a feature extraction process based at least in part on one or more seismic attributes).

In the example of FIG. 1, the simulation component 120 may process information to conform to one or more attributes specified by the attribute component 130, which may include a library of attributes. Such processing may occur prior to input to the simulation component 120. Alternatively, or in addition, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results, attributes, etc. In an example embodiment, output from the simulation component 120, the attribute component 130 or one or more other components may be input to one or more other workflows, as indicated by a workflow component 144 (e.g., for triggering another process).

In an example embodiment, the management components 110 may include features of a commercially available simulation framework such as the PETREL® seismic to simulation software framework. The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of simulating a geologic environment).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Tex.) allows for seamless integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. In an example embodiment, various components (e.g., or modules) may be implemented as add-ons (or plug-ins) that conform to and operate according to specifications of a framework environment (e.g., according to application programming interface (API) specifications, etc.).

FIG. 1 also shows, as an example, the framework 170, which includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization. Such a model may include one or more grids (e.g., that represent a geologic environment).

The model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

In the example of FIG. 1, the domain objects 182 can include entity objects, property objects and optionally other objects. Entity objects may be used to geometrically represent wells, surfaces, reservoirs, geobodies, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 158, which may be equipment to drill, acquire information, assist with resource recovery, etc. Other equipment 156 may be located remote from a well site and include sensing, detecting, emitting or other circuitry. Such equipment may include storage and communication circuitry to store and to communicate data, instructions, etc. The geologic environment 150 also shows various wells (e.g., wellbores) 154-1, 154-2, 154-3 and 154-4. In the example of FIG. 1, the downhole equipment 158 may include a drill for drilling the well 154-3.

The framework 170 may provide for modeling the geologic environment 150 including the wells 154-1, 154-2, 154-3 and 154-4 as well as stratigraphic layers, lithologies, faults, etc. The framework 170 may create a model with one or more grids, for example, defined by nodes, where a numerical technique can be applied to relevant equations discretized according to at least one of the one or more grids. As an example, the framework 170 may provide for performing a simulation of phenomena associated with the geologic environment 150 using at least a portion of a grid. As to performing a simulation, such a simulation may include interpolating geological rock types, interpolating petrophysical properties, simulating fluid flow, or other calculating (e.g., or a combination of any of the foregoing).

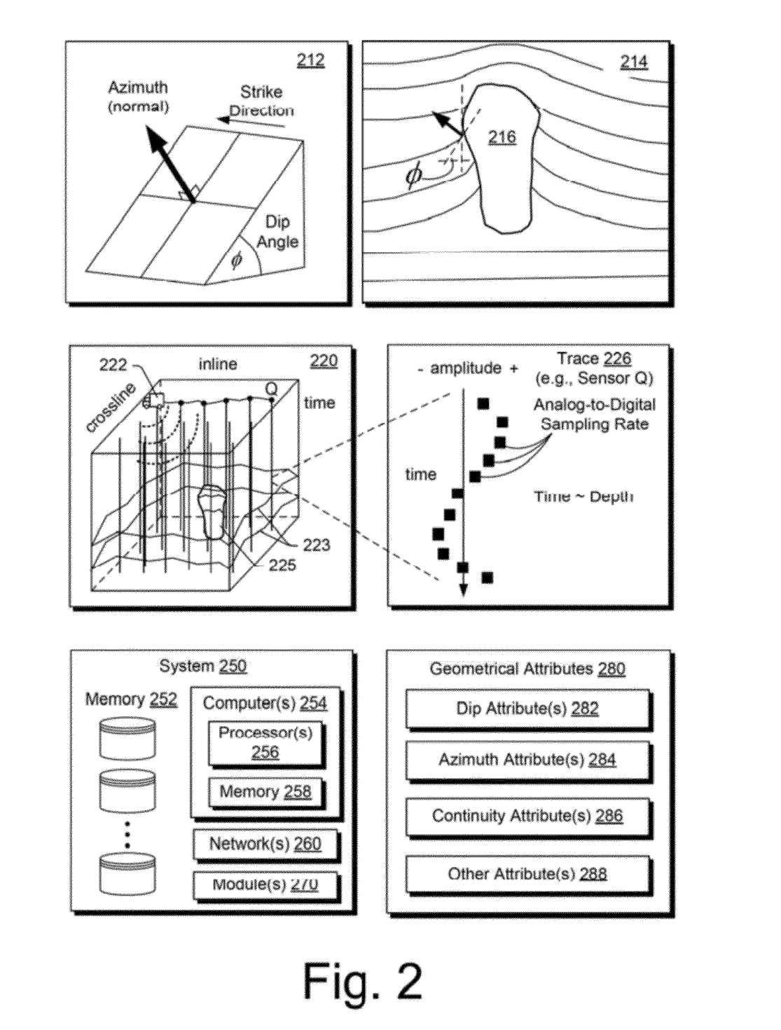

FIG. 2 shows a diagram for an example of dip angle and azimuth 212, a diagram of an example of a geobody 214, diagrams for examples of seismic data 220 and a portion of a trace 226, a block diagram of an example of a system 250 and a block diagram of examples of various geometrical attributes 280 (see also, e.g., the attribute component 130 of FIG. 1).

Seismic interpretation may aim to identify and classify one or more subsurface boundaries based at least in part on azimuth and dip angle. As shown in the diagram 212 of FIG. 2, azimuth may be defined as a direction normal to a surface whereas dip angle (e.g., or “dip”) may be defined as the angle of that surface. In terms of attitude, strike direction may be defined as a compass bearing of a horizontal line on a dipping layer where dip is the angle of the inclination of the bed measured perpendicular to the strike direction. Azimuth may be a perpendicular measure to a strike and be specified by a compass direction (e.g., 0 degrees to 360 degrees) of the normal to the strike plane. As an example, dip can be defined as the steepest angle of descent of a tilted bed or feature relative to a horizontal plane and may be specified using an angle between 0 degrees and 90 degrees and optionally a letter (e.g., N, S, E, and W) or other moniker to denote an approximate direction in which the bed is dipping. As an example, various types of features may be described, in part, by dip (e.g., sedimentary bedding, faults and fractures, cuestas, igneous dikes and sills, metamorphic foliation, etc.).

As shown in the diagram 214 of FIG. 2, a geobody 216 may be present in a geologic environment (see also, e.g., the geologic environment 150 of FIG. 1). For example, the geobody 216 may be a salt dome. A salt dome may be a mushroom-shaped or plug-shaped diapir made of salt and may have an overlying cap rock. Salt domes can form as a consequence of the relative buoyancy of salt when buried beneath other types of sediment. Hydrocarbons may be found at or near a salt dome due to formation of traps due to salt movement in association, evaporite mineral sealing. Buoyancy differentials can cause salt to begin to flow vertically (e.g., as a salt pillow), which may cause faulting. In the diagram 214, the geobody 216 is met by layers which may each be defined by a dip angle φ.

As mentioned, seismic data may be acquired for a region in the form of traces. In the example of FIG. 2, the diagram 220 shows acquisition equipment 222 emitting energy from a source (e.g., a transmitter) and receiving reflected energy via one or more sensors (e.g., receivers) strung along an inline direction. As the region includes layers 223 and a geobody 225, energy emitted by a transmitter of the acquisition equipment 222 can reflect off the layers 223 and the geobody 225. Evidence of such reflections may be found in the acquired traces. As to the portion of a trace 226, energy received may be discretized by an analog-to-digital converter that operates at a sampling rate. For example, the acquisition equipment 222 may convert energy signals sensed by sensor Q to digital samples at a rate of one sample per 4 ms. Given a speed of sound in a medium or media, a sample rate may be converted to an approximate distance. For example, the speed of sound in rock may be on the order of 5 km per second. Thus, a sample time spacing of 4 ms would correspond to a sample “depth” spacing of about 10 meters (e.g., assuming a path length from source to boundary and boundary to sensor). As an example, a trace may be about 4 seconds in duration; thus, for a sampling rate of one sample at 4 ms intervals, such a trace would include about 1000 samples where latter acquired samples correspond to deeper reflection boundaries. If the 4 second trace duration of the foregoing example is divided by two (e.g., to account for reflection), for a vertically aligned source and sensor, the deepest boundary depth may be estimated to be about 10 km (e.g., assuming a speed of sound of about 5 km per second).

In the example of FIG. 2, the system 250 includes one or more memory storage devices 252, one or more computers 254, one or more networks 260 and one or more modules 270. As to the one or more computers 254, each computer may include one or more processors (e.g., or cores) 256 and memory 258 for storing instructions (e.g., modules), for example, executable by at least one of the one or more processors. As an example, a computer may include one or more network interfaces (e.g., wired or wireless), one or more graphics cards, a display interface (e.g., wired or wireless), etc.

In the example of FIG. 2, the one or more memory storage devices 252 may store seismic data for a geologic environment that spans kilometers in length and width and, for example, 10 km in depth. Seismic data may be acquired with reference to a surface grid (e.g., defined with respect to inline and crossline directions). For example, given grid blocks of about 40 meters by about 40 meters, a 40 km by 40 km field may include about one million traces. Such traces may be considered 3D seismic data where time approximates depth. As an example, a computer may include a network interface for accessing seismic data stored in one or more of the storage devices 252 via a network. In turn, the computer may process the accessed seismic data via instructions, which may be in the form of one or more modules. As an example, a dip attribute module may be provided for processing seismic data.

In the example of FIG. 2, the geometrical attributes 280 include one or more dip attributes 282, one or more azimuth attributes 284, one or more continuity attributes 286, and one or more other attributes 288. Such attributes may be part of a structural attributes library (see, e.g., the attribute component 130 of FIG. 1). Structural attributes may assist with edge detection, local orientation and dip of seismic reflectors, continuity of seismic events (e.g., parallel to estimated bedding orientation), etc. As an example, an edge may be defined as a discontinuity in horizontal amplitude continuity within seismic data and correspond to a fault, a fracture, etc. Geometrical attributes may be spatial attributes and rely on multiple traces.

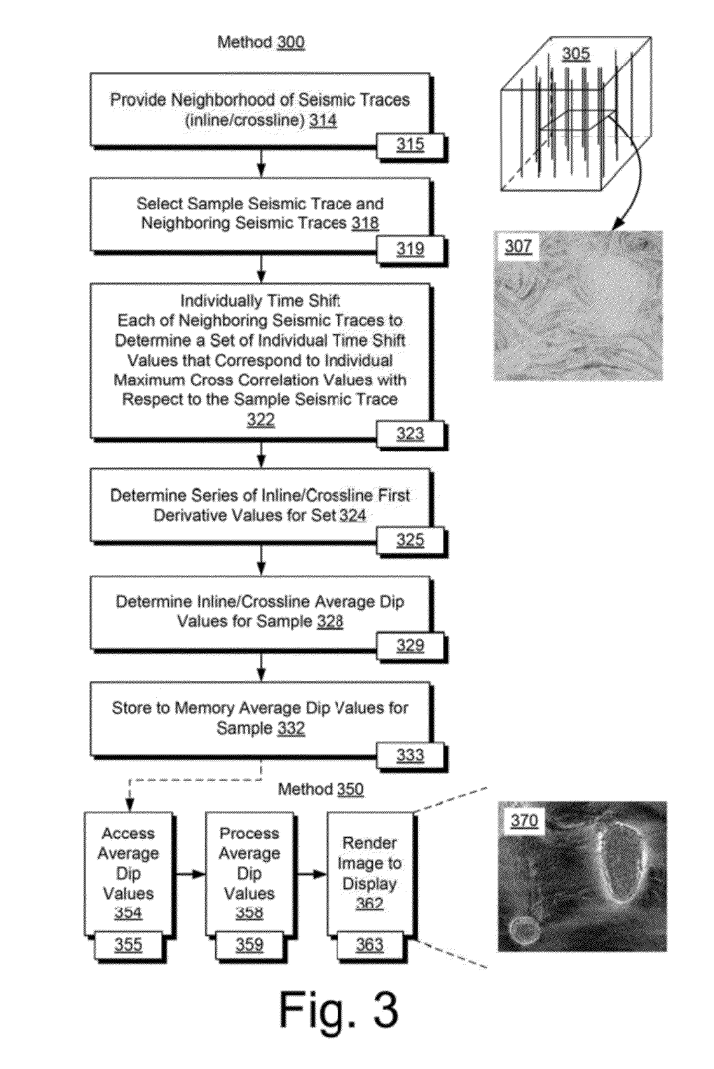

FIG. 3 shows an example of a method 300 for a dip attribute and an example of a method 350 for rendering dip attribute values to a display. The method 300 includes a provision block 314 for providing a neighborhood of seismic traces (e.g., inline and crossline) and a selection block 318 for selecting a sample seismic trace and neighboring seismic traces. As an example, the provision block 314 may provide traces by accessing seismic traces stored in a storage device (e.g., optionally via a network). Given the selected sample seismic trace, the method 300 includes a determination block 322 that determines a set of individual time shift values for each of the neighboring seismic traces with respect to the selected sample seismic trace. As an example, the determination block 322 includes individually time shifting each of the neighboring seismic traces to maximize a corresponding cross correlation value with respect to the selected sample seismic trace.

As mentioned, indicia of reflection may be found in a seismic trace. Thus, given a sample seismic trace and a neighboring seismic trace that were both collected over a dipping boundary, indicia of reflection in the two seismic traces may be offset in time. By successively shifting the neighboring seismic trace in time and performing a cross correlation between the shifted neighboring seismic trace and the fixed sample seismic trace for each successive shift, a maximum may be reached in a cross correlation value when the total shift of the neighboring seismic trace “aligns” the indicia of reflection of the dipping boundary with that of the sample seismic trace. In such an example, a downward shift in time corresponds to an upward dip angle between the neighboring seismic trace and the selected sample seismic trace and an upward shift in time corresponds to a downward dip angle between the neighboring seismic trace and the selected sample seismic trace.

While the foregoing example refers to shifting a neighboring seismic trace, as an alternative, a sample seismic trace may be shifted or both a sample seismic trace and a neighboring seismic trace may be shifted. In any of the foregoing examples, a value may be determined that represents how much shift occurred between the sample seismic trace and the neighboring seismic trace to achieve a maximum cross correlation value between the two. Such a “shift” may be given in distance, time, increments or steps, etc.

In the method 300, given the set of individual time shift values, a determination block 324 provides for determining a series of inline first derivative values and for determining a series of crossline first derivative values. As shown in the example of FIG. 3, another determination block 328 follows that provides for determining an inline average dip value for the selected sample seismic trace and determining a crossline average dip value for the selected sample seismic trace. A storage block 332 may follow that provides for storing to memory (e.g., a memory storage device) the average dip values for the selected sample seismic trace.

In the example of FIG. 3, the method 350 includes an access block 354 that provides for accessing average dip values, a process block 358 that provides for processing average dip values and a render block 362 that provides for rendering an image to a display based at least in part on the processed average dip values.

In the example of FIG. 3, a 3D block of seismic data 305 is shown as including information that may be rendered as an image 307 to a display. After processing the seismic data 305 according to the method 300, per the method 350, a dip attribute based image 370 may be rendered to a display. By comparing the image 307 to the image 370, features such as salt dome boundaries become readily apparent as high intensity pixel values, which correspond to high average dip values within the image plane (e.g., a time or depth window in the seismic data 305). Other features such as faults and channels may further become apparent.

The method 300 is shown in FIG. 3 in association with various computer-readable media (CRM) blocks 315, 319, 323, 325, 329, and 333 and the method 350 is shown in FIG. 3 in association with various CRM blocks 355, 359, and 363. Such blocks generally include instructions suitable for execution by one or more processors (or cores) to instruct a computing device or system to perform one or more actions. While various blocks are shown, a single medium may be configured with instructions to allow for, at least in part, performance of various actions of the method 300, the method 350 or both. As an example, a computer-readable medium (CRM) may be a computer-readable storage medium. As an example, the memory 258 of FIG. 2 may provide for storage of instructions executable by one or more of the one or more processors 256 of FIG. 2. Thus, the memory 258 may be a CRM as in FIG. 3.

As an example, a method can include: providing a neighborhood of seismic traces along inline and crossline directions; within the neighborhood, selecting a sample seismic trace and neighboring seismic traces; individually time shifting each of the neighboring seismic traces with respect to the sample seismic trace to determine a set of individual time shift values that correspond to individual maximum cross correlation values for each of the neighboring seismic traces with respect to the sample seismic trace; determining a series of inline direction first derivative values for the set of time shift values; determining a series of crossline direction first derivative values for the set of time shift values; determining an inline average dip value based on the series of inline first derivative values; determining a crossline average dip value based on the series of crossline first derivative values; and storing to a memory storage device, coordinates for the sample seismic trace, the inline average dip value, and the crossline average dip value. As an example, such a method may also include accessing previously stored inline average dip values and crossline average dip values for other sample seismic traces, processing the average dip values for the sample seismic trace and the other seismic sample traces and rendering to a display an image based at least in part on the processing.

As an example, a method may include identifying a fault, a channel, a salt body (e.g., a salt dome) or another feature in an image rendered to a display. As an example, an image may be based on directional processing of average dip values along an angle between an inline direction and a crossline direction. In such an example, the processing may include use of an Euler equation. Directional processing may act to mute information in one or more directions; thus, such processing may provide for direction muting.

As an example, a method may commence responsive to receipt of an instruction input via a graphical user interface. For example, such a graphical user interface may include an attribute menu that includes a dip attribute as a menu entry.

As an example, a method may include individually time shifting each seismic trace within a neighborhood of a sample seismic trace to determine a set of individual time shift values that correspond to individual maximum cross correlation values for each of the neighboring seismic traces with respect to the sample seismic trace. Such a time shifting process may include, for each of the neighboring seismic traces, determining a cross correlation value for a positive time shift value, a cross correlation value for a negative time shift value and a cross correlation value for a zero time shift value; comparing the cross correlation values; based on the comparing, determining additional cross correlation values for either greater positive time shift values or greater negative time shift values until a decrease occurs in one of the cross correlation values; and responsive to the decrease, assigning a time shift value that corresponds to a maximum cross correlation value.

As an example, a system can include one or more processors; memory; and instructions stored in the memory and executable by at least one of the one or more processors to access seismic traces, determine time shift values for pairs of the seismic traces where a time shift value for a pair of seismic traces corresponds to a maximum cross correlation value for the pair, process the time shift values to provide dip angle values, and render to a display an image based at least in part on the dip angle values. In such a system, the instructions to determine time shift values for pairs of the seismic traces may include instructions to shift one seismic trace of the pair with respect to the other seismic trace of the pair. As an example, instructions to process time shift values may include instructions to determine slopes based on the time shift values, instructions to provide directional dip angle values, instructions to provide dip angle magnitude values or other instructions. As an example, a system may include a display (e.g., with an appropriate display interface or interfaces) and instructions to render a graphical user interface to the display for input to adjust one or more parameters associated with instructions to process the time shift values. For example, for directional processing, such a graphical user interface may allow a user to input an angle (e.g., optionally using a pointing device, a touch display, a keyboard, a voice command, etc.).

As an example, one or more computer-readable storage media can include computer-executable instructions to instruct a computing device to: access weighted average inline dip angle values and weighted average crossline dip angle values; select an algorithm from a group of algorithms that includes a directional dip algorithm and a dip magnitude algorithm; and apply the selected algorithm to the weighted average inline dip angle values and the weighted average crossline dip angle values to generate image data. In such an example, instruction may be included to render an image to a display based on the generated image data.

As an example, one or more computer-readable storage media may include computer-executable instructions to instruct a computing device to implement a directional dip algorithm that includes the following equation:

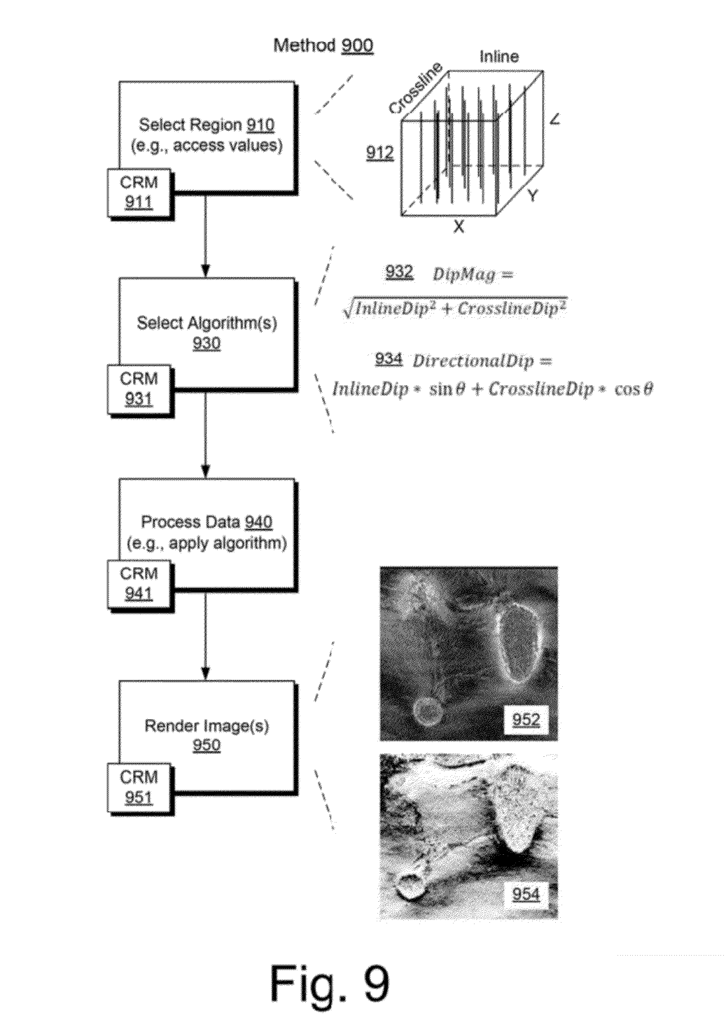

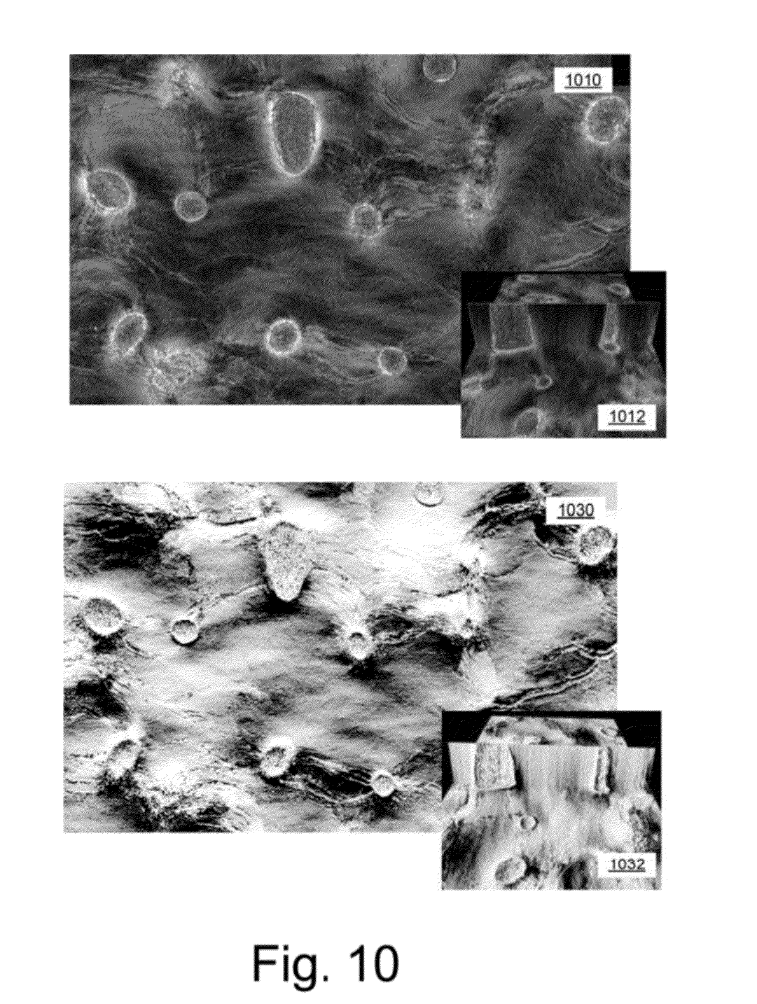

DirectionDip=InlineDip*sin Θ+XlineDip*cos Θ

where InlineDip represents a weighted average inline dip angle value, XlineDip represents a weighted average crossline dip angle value and Θ is a directional angle (see also, e.g., FIG. 9 and FIG. 10). The directional angle may be a user selectable angle, for example, selectable via a graphical user interface rendered to a display. As to some examples that can use a directional dip algorithm, a user may select a directional angle and initiate determination of attribute values and rendering of a view to a display based at least in part on the attribute values or may select multiple directional angles and initiate determination of attribute values and rendering of multiple views to a display based at least in part on the attribute values.

As an example, one or more computer-readable storage media may include computer-executable instructions to instruct a computing device to implement a dip magnitude algorithm that includes the following equation:

$$DipMag = \frac{{InlineDip}^{2} + {XlineDip}^{2}}{\sqrt{{InlineDip}^{2} + {XlineDip}^{2}}}$$

where InlineDip represents a weighted average inline dip angle value and XlineDip represents a weighted average crossline dip angle value.

As an example, one or more computer-readable storage media may include computer-executable instructions to instruct a computing device to implement a dip magnitude algorithm that includes the following equation:

DipMag=\sqrt{InlineDip²+XlineDip²}

where InlineDip represents a weighted average inline dip angle value and XlineDip represents a weighted average crossline dip angle value.

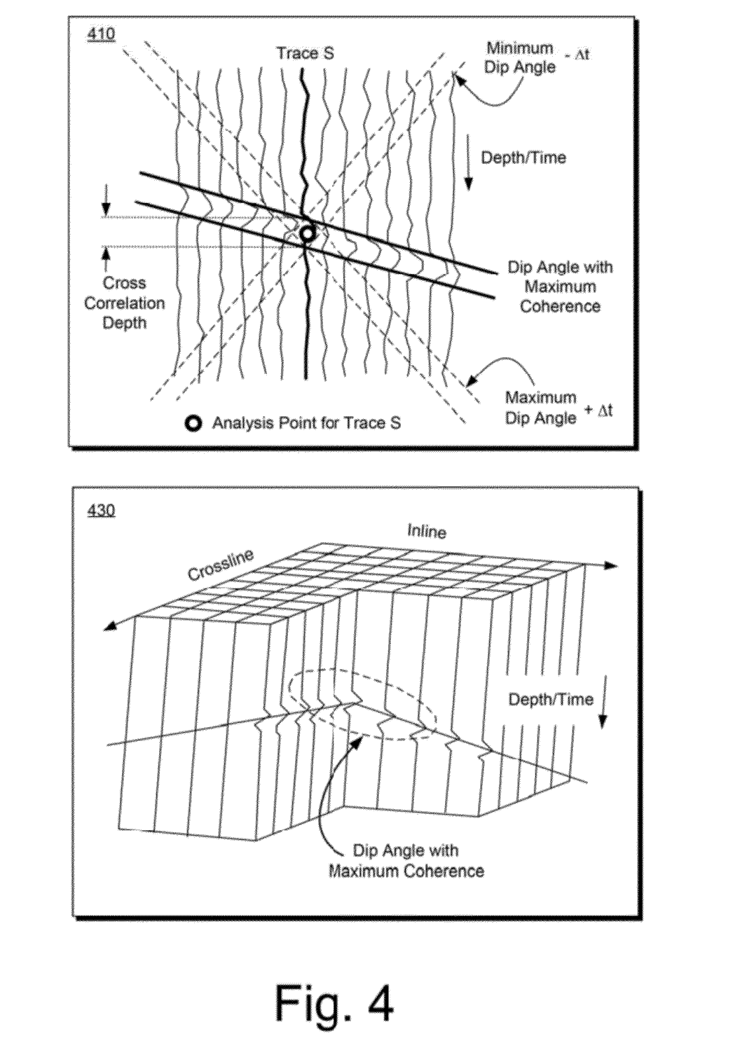

As mentioned, seismic data for a region may include one million traces where each trace includes one thousand samples for a total of one billion samples. Resources involved in processing such seismic data in a timely manner may be considerable. FIG. 4 shows a 2D diagram 410 and a 3D diagram 430 of a dip scan approach, which involves processing seismic data with respect to discrete planes (e.g., a volume bounded by discrete planes). Depending on the size of the seismic data, such an approach may involve considerable resources for timely processing.

The approach shown in FIG. 4 may look at local coherence between traces and their amplitudes, and therefore may be classified in the category of “apparent dip.” When using seismic attributes, the result and volumes may be noisy, which can impact voxel-based segmentation interpretation. Another approach, referred to at times as “dip estimation” can help to remove at least some geological noise. The method 300 of FIG. 3 may be considered as including a dip estimation approach. Such an approach can be suitable for revealing structures in seismic data, for example, by delineating salt and other structures.

Referring to the diagram 410 of FIG. 4, a 2D search-based estimate of coherence is shown with respect to a range of discrete dip angles. Such an approach may estimate coherence using semblance, variance, principle component analysis (PCA), or another statistical measure along a discrete number of candidate dips and arrive at an instantaneous dip based on a coherence peak. The diagram 430 of FIG. 4 shows a 3D search-based estimate of coherence, which is analogous to the 2D approach shown in the diagram 410 and may use an inline vector and a crossline vector for time dip (e.g., along coherent peaks in inline and crossline directions).

As described in various example embodiments, a dip estimation approach may involve determinations of “apparent dip” and “local amplitude correlation”. As to local amplitude correlation, to arrive at a maximum local amplitude correlation value for two traces, a statistical technique such as gradient descent (e.g., “hill climb”) may be implemented. Where a set of time shift values that correspond to maximum local amplitude correlation values are determined, first derivatives of those values may be taken, for example, in inline and crossline directions (e.g., using a five point estimate). As an example, consider a 5×5 matrix of time shift values where 5 inline slopes and 5 crossline slopes may be determined (e.g., noting that time can equate to depth). Given a series of inline slopes and a series of crossline slopes, each of these series may be averaged, optionally using weighted averaging, to arrive at an inline slope or dip estimate and a crossline slope or dip estimate (e.g., for a center point of the 5×5 matrix). Such averaging results in a smoothing effect, which can enhance an image and optionally be adjusted by a user during visualization (e.g., different weighting, different matrix size, etc.).

As to correlation between two seismic traces, as an example, an explicit dip scan approach may be implemented to find the most coherent reflector. For example, an explicit dip scan may be performed by scanning for the dip where the trace to trace cross correlation is maximized. This procedure may be repeated for every sample in a seismic volume, and comparing against neighbor traces. Cross correlation may be calculated within a window of +/−N_{S} samples from a center sample, for example, where the sample weight gradually decreases away from the center sample (e.g., using weighted Pearson cross correlation). The sample amplitude values from one trace may be held fixed, while the amplitudes from another trace may be interpolated to be able to extract amplitudes at any position from that trace. A search for a maximum may include a discrete search using, for example, a greedy hill climb algorithm. Such an algorithm may search with a fixed step size until it finds a correlation maximum, possibly a local one. After finding the approximate maximum position (e.g., posₘ), a “true” maximum position may be estimated using, for example, Newton's method (e.g., posₘₐₓ=posₘ−[f′(posₘ)/f″(posₘ)]). Given traces to neighbor trace dips for a selection of samples, an example embodiment may estimate the dip at each sample in a volume by using a weighted average of a neighborhood around that sample. An output may include, for example, apparent dip in a specified direction (e.g., specified by a user), the dip, or other metric. As to an apparent dip, both positive and negative dip visualization may be possible. As to dip, as an example, an output may provide the steepest dip at a point, which may optionally be defined as being in either a downward direction or an upward direction for all points (e.g., dip without a plus or minus sign).

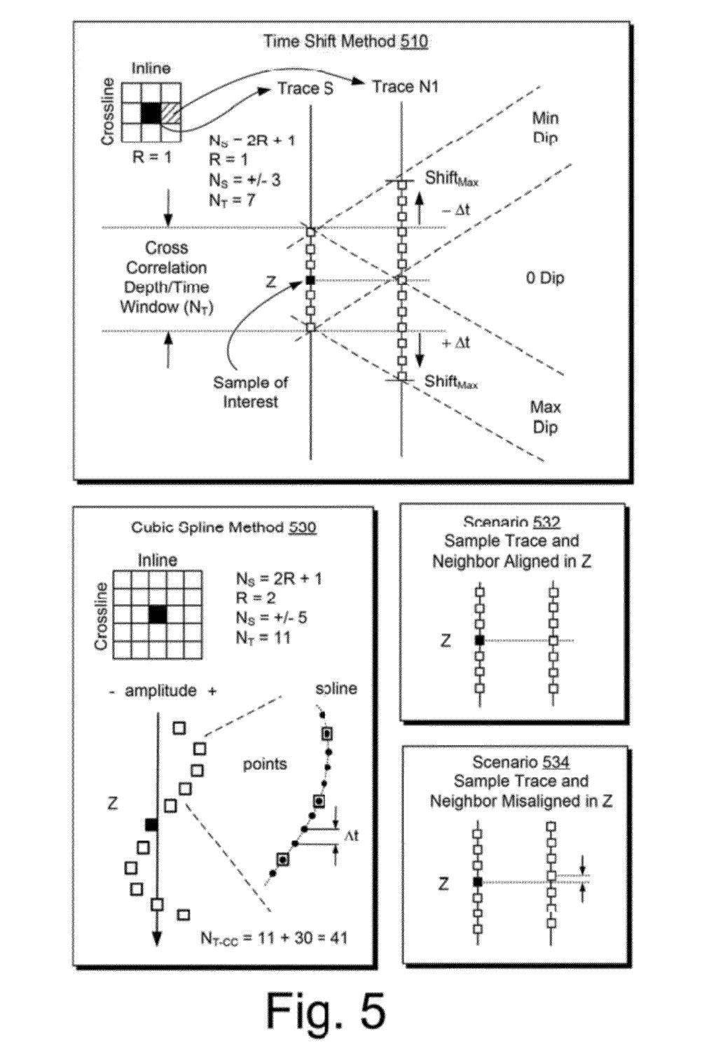

FIG. 5 shows an example of a time shift method 510, an example of a cubic spline method 530, and two example scenarios 532 and 534. In FIG. 5, the time shift method 510 is described, as an example, for a 3×3 inline and crossline neighborhood centered on a selected sample trace. As to depth, a number of data samples N_{S} along the sample trace are determined based on a neighborhood radius R, which equals 1 for the 3×3 neighborhood. For example, the equation N_{S}=2R+1 may provide for determining a number of samples N_{S} above and below a sample of interest of the sample trace (e.g., in FIG. 5, where R=1, the total number of samples N_{T}=7).

In FIG. 5, the example time shift method 510 involves maintaining the time (e.g., depth) position of the sample trace S and, accordingly, its sample of interest +/−N_{S} samples above and below. As to time shifting, this occurs for a neighboring trace, for example, trace N1. As indicated in FIG. 5, time shifting may shift a neighboring trace upward in time or downwards in time. Time shifting may occur incrementally, for example, according to a time step, counter, etc. As to minimum dip and maximum dip, time shifting upward in time means that indicia in the neighboring trace N1 was below that of the sample trace S (i.e., the indicia had to be brought upward to match or correlate with indicia in the sample trace S) and time shifting downward in time means that indicia in the neighboring trace N1 was above that of the sample trace S (i.e., the indicia had to be brought downward to match or correlate with indicia in the sample trace S).

As to a search for a maximum cross correlation value, time shifting may include one or more limits. A limit may be set according to a distance between a sample trace and a neighboring trace, which, in turn, may allow for determination of a corresponding angle for the limit (e.g., using the Pythagorean theorem). As an example, time shifting may be limited to three samples upward and three samples downward where the three sample limits corresponds to angles of about −70 degrees and +70 degrees. Effort spent time shifting more than about +/−70 degrees may result in diminishing returns depending on the nature of a feature or features in a geologic environment.

As to the method 530, as an example, a cubic spline or other interpolation technique may be applied to one or more traces to increase a number of points for performing a cross correlation. For example, a cubic spline may be fit to amplitude values for a series of times of a trace. In such an example, the spline may allow for increasing a number of points by a factor of two or more. In turn, a time step Δt may be defined based on the increased number of points (e.g., rather than the sampling rate for the trace). Such a technique can improve cross correlation (e.g., more points) and improve time shift value determination (e.g., finer Δt).

As to the scenario 532, a sample of a neighbor trace (e.g., data point in time) may substantially align with a sample of a sample trace. As to the scenario 534, a sample of a neighbor trace may be misaligned with a sample of a sample trace. Where traces are misaligned, as an example, a spline method may be applied and one or more samples or points selected to diminish such misalignment. Such an approach may improve accuracy of geometrical metrics derived from a time shift method.

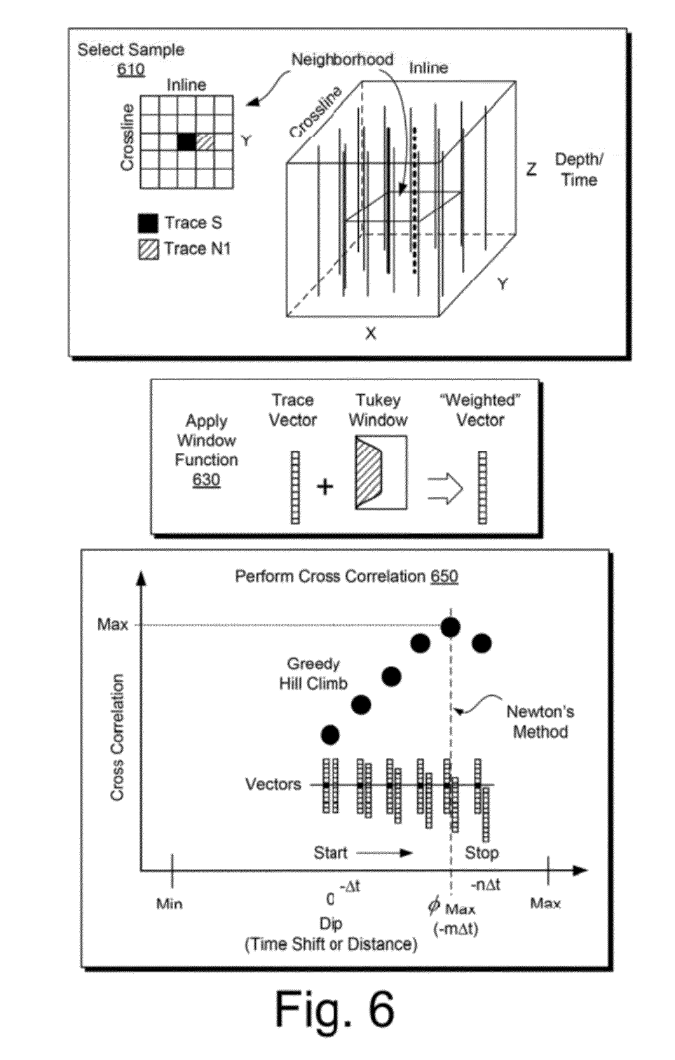

FIG. 6 shows an example of a sample selection process 610, an example of a window function application process 630 and an example of a cross correlation process 650. In the sample selection process 610, a sample trace S is selected from a volume of seismic data organized in inline and crossline directions as well as depth or time. For that sample trace S, a sample of interest along the Z direction is selected about which an inline and crossline neighborhood is defined.

As mentioned with respect to FIG. 5, a number of samples can be selected above and below the sample of interest of the sample trace S. Collectively, such samples may form a vector (e.g., of amplitude values). Where a spline technique is implemented, a vector may include a number of values that exceeds a number of samples along a trace (e.g., whether for a sample trace or a neighboring trace). To focus on the sample of interest (e.g., center of a time window), a window function may be applied to the number of samples or number of total points (e.g., as increased via use of a spline technique). In the example of FIG. 5, the window function application process 630 applies a tukey window (e.g., a tapered cosine function) to diminish influence of upper and lower values, for example, to provide a weighted vector (e.g., or filtered vector).

As to the cross correlation process 650, the process may commence by first determining whether cross correlation values are increasing in the direction of a positive time shift or a negative time shift. For example, given a time step, cross correlation values for a neighboring trace with respect to a sample trace may be initially determined for an upward shift in time, no shift in time and a downward shift in time. The process 650 may then determine a direction in which to proceed based on the direction in which cross correlation values are increasing. For the example of FIG. 5, the cross correlation values are shown as increasing in a direction that corresponds to a negative time shift. As indicated, the process 650 continues incrementally in time (or depth) until a cross correlation value decreased (e.g., or a limit is reached). Next, the process 650 may perform Newton's method on a particular number of cross correlation values to determine a “true” peak. Given the true peak, a time shift value may be determined, which may optionally be a fraction of a whole time step. As mentioned, time relates to depth, thus, a time shift value may have units of time, distance, steps (e.g., including fractional steps), etc.

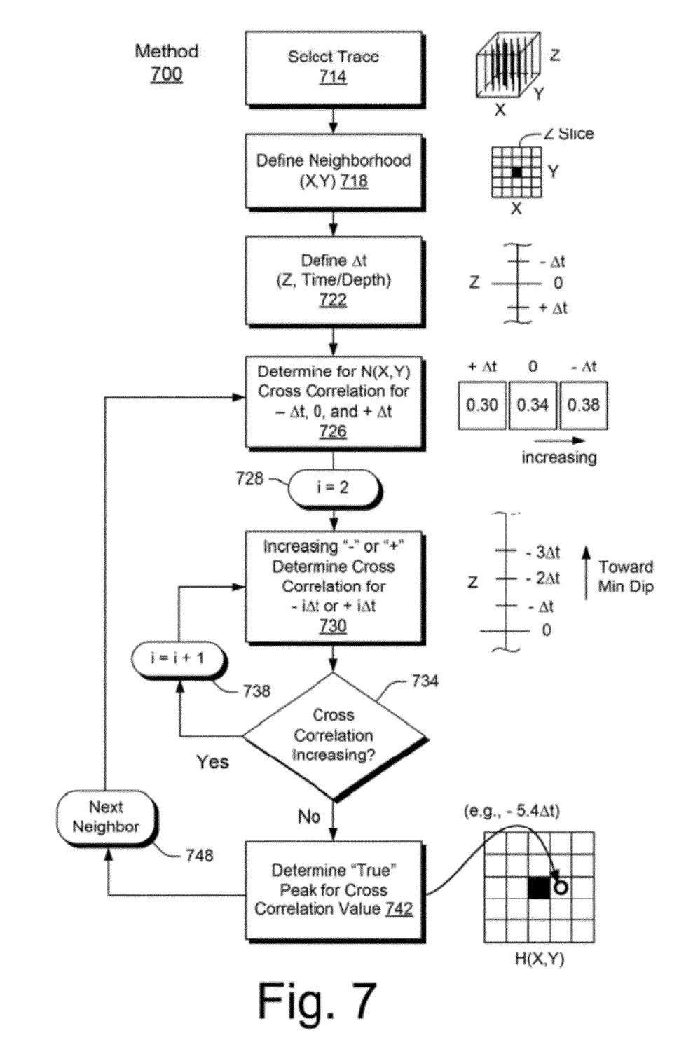

FIG. 7 shows an example of a method 700 that includes a selection block 714 for selecting a trace, a definition block 718 for defining a neighborhood about a selected trace, another definition block 722 for defining a time step, a determination block 726 for determining a time step direction to proceed for a neighboring trace, a set block 728 for setting a time step index, another determination block 730 for determining a cross correlation value for a time step (e.g., as indexed), a decision block 734 for deciding whether a cross correlation value is increasing in comparison to a value for a prior time step, an increment block 738 for incrementing a time step index, another determination block 742 to determine a “true” peak for the cross correlation values and a corresponding time shift value and another increment block 748 for consideration of another neighboring trace.

As indicated in FIG. 7, the method 700 may populate a matrix H(X,Y) with a set of time shift values. As mentioned, based on determination of a “true” peak in cross correlation versus time shifts, the corresponding time shift value may include a fraction of a time shift (e.g., −5.4 Δt). Regardless of whether a trace is organized with respect to time or depth, the matrix H(X,Y) may be considered a height-field where each entry is a shift “height” identified for shifting a neighboring trace to provide a maximum cross correlation value with a sample trace. In the example of FIG. 7, where the sample trace is H(2,2), this entry would have a value of zero and the neighboring entries of the matrix would have various values as determined by the method 700, which may be positive or negative.

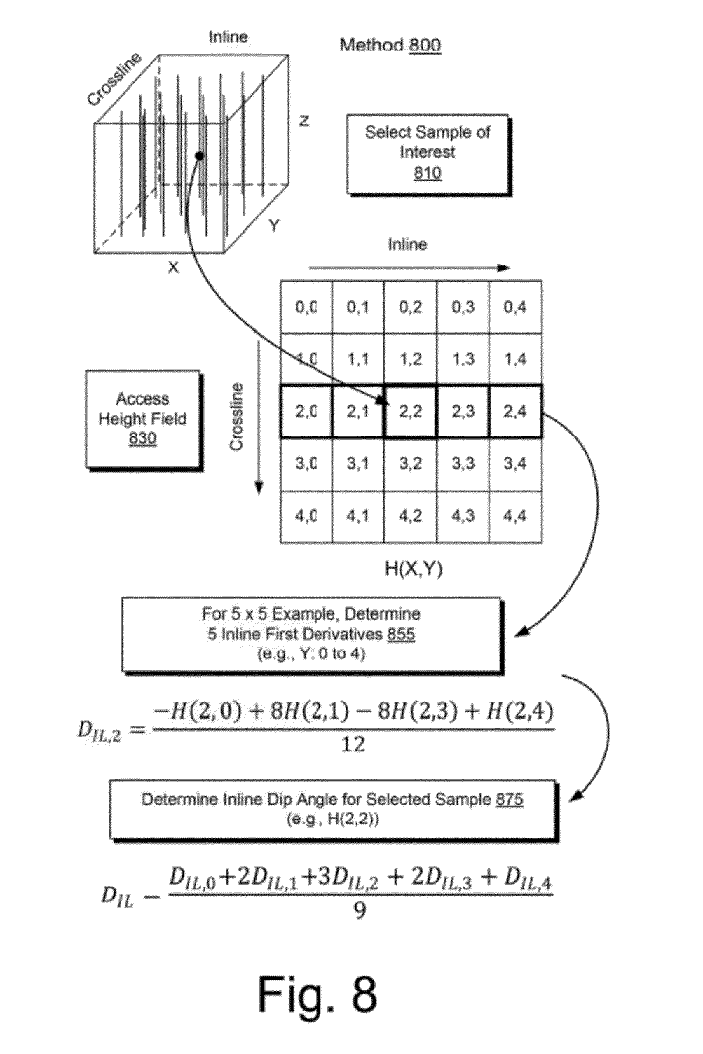

FIG. 8 shows an example of a method 800 for determining an inline dip value for a sample of interest, which may be applied for determining a crossline dip value for a sample of interest. In the method 800, a selection block 810 provides for selecting a sample of interest in a volume, an access block 830 provides for accessing a height field for the selected sample of interest (e.g., a matrix with inline and crossline time shift values), a determination block 855 provides for determining inline first derivative values for each of the inline series of entries in the height field, and another determination block 875 provides for determining an average inline dip angle for the selected sample of interest. In the example of FIG. 8, another block (not shown) can provide for determining crossline first derivative values for each of the crossline series of entries in the height field and yet another block (not shown) can provide for determining an average crossline dip angle for the selected sample of interest. Accordingly, the method 800 can provide, for each selected sample of interest, a corresponding average inline dip angle and an average crossline dip angle.

As shown in FIG. 8, a first derivative may be determined using, for example, a five point equation and an average value may be a five point weighted average, for example, where a center value is weighted highly than end values. Such an approach provides for localized smoothing across a neighborhood. As mentioned, a neighborhood may be determined based on one or more parameters, for example, which may have default values or may be input by a user that has selected a dip attribute analysis option. As an example, consider a user selecting a smaller neighborhood where one or more features have a shorter characteristic length and a larger neighborhood where one or more features have a longer characteristic length. Further, options may exist as to tailoring a window function, a spline function, etc., to allow for enhancing visualization of one or more features.

FIG. 9 shows an example of a method 900 that includes a selection block 910 for selecting a region, another selection block 930 for selecting one or more algorithms, a process block 940 for processing data for the selected region using the one or more selected algorithms, and a render block 950 for rendering one or more images to a display based at least in part on the processing.

In the example of FIG. 9, the selection block 910 may select a region for which seismic data 912 exists, which may have already been processed according to a dip attribute. As an example, the selection block 910 may access values for a region (e.g., dip angle values) from a data storage device (e.g., optionally via a network). As to the selection block 930, it may provide for selection of one or more of a dip magnitude algorithm 932, a directional dip algorithm 934 or other algorithm. The process block 940 may process the seismic data 912 for a selected region according to the one or more selected algorithms, for example, using one or more processors, memory, etc. As an example, the process block 940 may apply a selected algorithm to accessed weighted average inline dip angle values and accessed weighted average crossline dip angle values to generate image data. For example, such processing may store processed values to memory (e.g., a memory storage device) where such values may be pixel values or voxel values suitable for access by a video graphics card (e.g., or CPU-based graphics). As an example, the render block 950 may provide for accessing stored, processed values by one or more video graphics cards and then rendering these values to a display device. In the example of FIG. 9, an image 952 corresponds to data processed using the dip magnitude algorithm 932 and the image 954 corresponds to data processed using the directional dip algorithm 934 (e.g., where Θ is a directional angle, which may be a parameter of the directional dip algorithm 934).

The method 900 is shown in FIG. 9 in association with various computer-readable media (CRM) blocks 911, 921, 931, 941, and 951. Such blocks generally include instructions suitable for execution by one or more processors (or cores) to instruct a computing device or system to perform one or more actions. While various blocks are shown, a single medium may be configured with instructions to allow for, at least in part, performance of various actions of the method 900. As an example, a computer-readable medium (CRM) may be a computer-readable storage medium. As an example, FIG. 2 shows one or more processors 256 and memory 258, which may be a computer-readable storage medium.

FIG. 10 shows an example image 1010 and an example image 1030 for, after having calculated dip values for inline and cross-line directions, two ways of visualizing data. FIG. 10 also shows partially inset an example image 1012 and an example image 1032, which provide a three-dimensional perspective of processed data.

As an example, a visualization process may consider dip values to be a height-field upon which a light source may cast shadows. In the image 1010, a light source is positioned perpendicular to the plane viewed (or the dip magnitude). For the time-slice associated with the image 1010, with perpendicular lighting, white is steep and black is flat, which highlights salt structures (circular shapes in the image) and fault structures that are the discontinuities between the salt structures. In the image 1030, a light source is positioned along the azimuth of the plane, which can be rotated around the view plane (e.g., calculated using the Euler equation). For the time-slice associated with the image 1030, with directional lighting along the crossline direction, salt structures and fault structures are also highlighted.

As an example, dip magnitude may be determined as the absolute value of dip, which can act to highlight steep dips, bumps and curves to provide a user with a more geologically correct image. Such an approach can also highlight edges, especially around salt data.

Referring again to the image 1010, several discontinuities exist (e.g., in this case faults), which indicates that the approach picks up on various types of structural geology with a high level of detail reflecting even minor changes in dip in the seismic data. In the image 1010, slopes and anticline features are visible as well, giving an overall better picture and understanding of the subsurface. However, such an extensive amount of detail could possibly be considered as geological noise, which could create issues when interpreting the seismic data. To assist in discrimination of noise from features, one may select another algorithm, for example, to steer lighting directionally along the azimuth of the viewing plane. In the image 1030, the same seismic data has been processed but with the light source along the crossline direction.

The approach taken in forming the image 1030 may be considered to involve muting certain information, for example, muting information that is not relevant in the perpendicular direction, which can help discriminate or reduce noise. As an example, directional muting may be achieved via use of the Euler equation on the inline and cross line dip estimates (see, e.g., the algorithm 934 of FIG. 9).

A directional algorithm applied to dip values can, for example, enhance detection of salt, fault, anti-cline and sync-line structural features as well as channels that may be considered stratigraphic (e.g., noting that an indication of their stacking may also be seen).

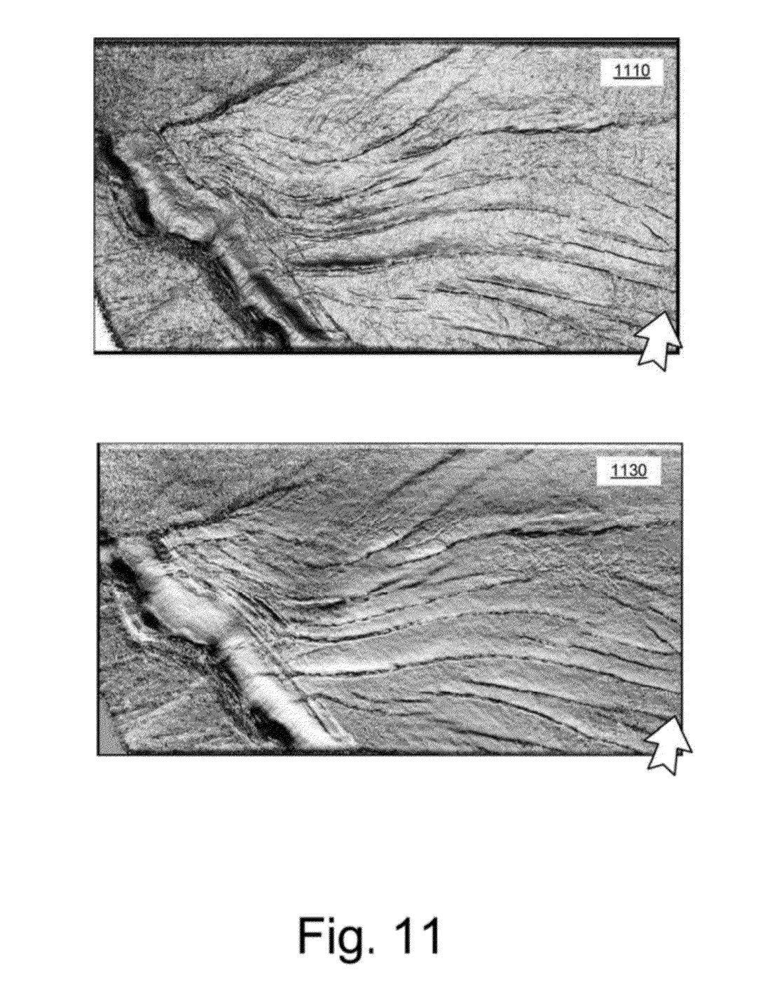

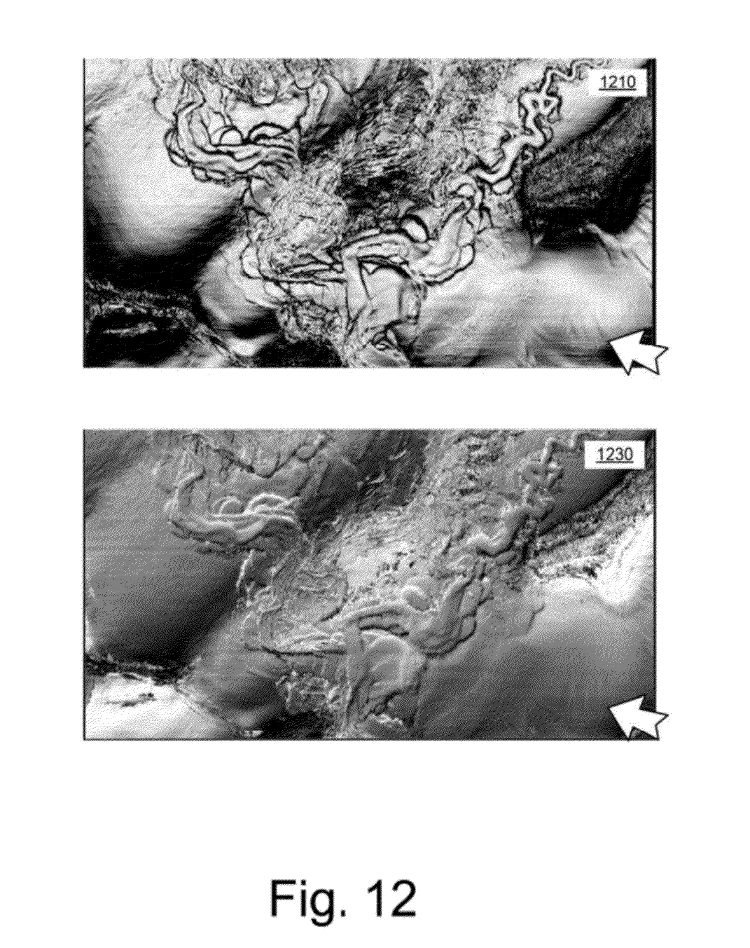

FIGS. 11 and 12 show examples of images 1110, 1130, 1210 and 1230. As to the image 1110, it corresponds to seismic data for a time-slice showing dip with perpendicular lighting, where black is steep and white is flat. In the image 1110, highlighted features include fault structures, which are the black line segments, and the anti-cline that is the dome shape in the bottom left corner of the image. As to the image 1130, it corresponds to the seismic data for the time-slice of the image 1110 but showing dip with directional lighting along the crossline direction. In the image 1130, highlighted features include fault structures, which are the black line segments, and the anti-cline that is the dome shape in the bottom left corner of the image.

As to the image 1210, it corresponds to seismic data for a time-slice showing dip with perpendicular lighting, where black is steep and white is flat. In the image 1210, highlighted are channels and meandering systems (e.g., see middle of the image) and a salt structure (e.g., see top right corner), which is covered by a black edge due to the steepness of the stratigraphy around it; also, one may note stacking information within the channel borders. As to the image 1230, it corresponds to the seismic data for the time-slice of the image 1210 but showing dip with directional lighting along the crossline direction. In the image 1230, channels and meandering systems and the salt structure are highlighted.

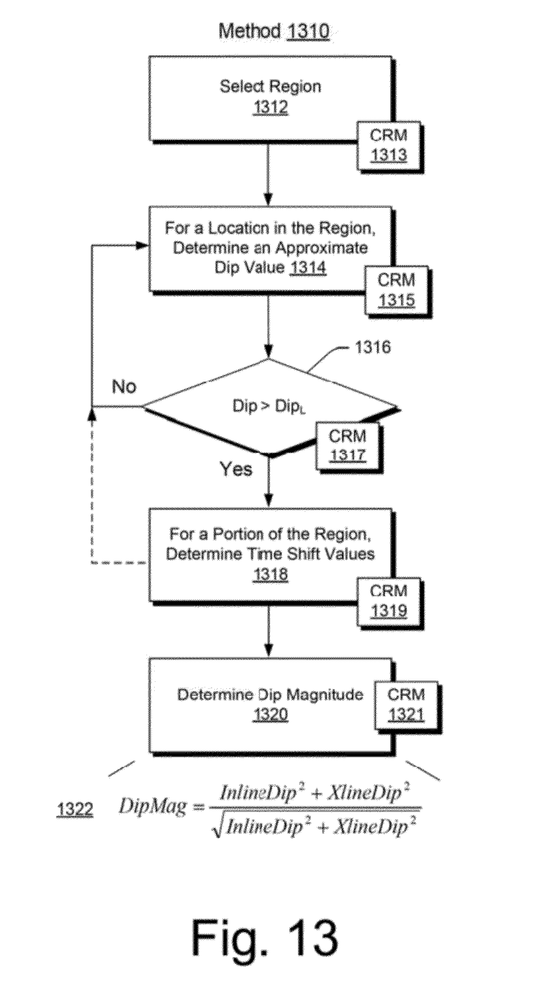

FIG. 13 shows an example of a method 1310 that includes a preliminary determination of approximate dip prior to implementing a time shifting cross correlation process to determine time shift values (e.g., to generate a height field). In the example of FIG. 13, the method 1310 includes a selection block 1312 to select a region, a determination block 1314 to determine approximate dip values for various locations in the region, a decision block 1316 to compare each approximate dip value to a dip limit value and a determination block 1318 to determine time shift values for traces within a portion of the region where an approximate dip value exceeds the dip limit value. As indicated, if the decision block 1316 decides that an approximate dip value does not exceed a dip limit value, then the method 1310 continues to the determination block 1314. The method 1310 may aim to expedite processing, reduce demand on resources, etc., with respect to computations for a dip attribute.

In the example of FIG. 13, yet another determination block 1320 is shown, which may provide for determination of dip magnitude values based at least in part on the time shift values. For example, the time shift values may be processed using first derivative equations to provide inline and crossline slopes, which may be subsequently processed to provide an average inline dip value and an average crossline dip value for each point in the portion of the region. As to the determination block 1320, it may include an equation 1322 for determining a dip magnitude value based on an inline dip value and a crossline dip value for a point in the portion of the region.

As an example, the determination block 1314 of the method 1310 may include determining an instantaneous dip value by calculating dip locally by looking at a neighborhood of N samples in each dimension (e.g., where N is about 3). In each dimension, the determination block 1314 may calculate a point estimate of a derivative of a seismic signal (e.g., amplitude) and use these values to calculate an inline dip value and a crossline dip value. To provide a robust approximation of dip, the determination block 1314 may take the median of a number of closest point estimates along the trace for each sample (e.g., about 11). In such an example, the decision block 1316 decides that the approximate dip value is indicative of a steep dip, the method 1310 may proceed to a dip scan method to re-estimate the dip (e.g., via the time shifting approach).

In an example embodiment, a method can include double checking and correcting steepest dips, for example, to reduce a number of outlier dip estimates. Such a method can include a hybrid dip estimation technique that uses a combination of a spatially smoothed gradient method estimates and a dip scan that maximizes cross correlation between neighboring traces. Such a method may provide detailed dip fields with less computational demands when compared to a method that includes eigenvector analysis of a gradient structure tensor (e.g., GST approach). As an example, after having calculated Inline and crossline dip values, a method may include calculating dip magnitude values using the equation 1322 of FIG. 13.

In comparison to a GST approach, a dip scan approach that includes time shifting individual traces can provide for more detailed images and be more conservative when it comes to steeper dipping regions. For example, such a dip scan approach can provide for sharper steep dipping boarders around salt structures when compared to an original seismic image. As to fault structures, a dip scan approach can provide for enhanced consistency as to the direction of the dipping features. Such an approach can provide overall better image for interpretation and a more accurate estimation and representation of a dip.

As mentioned, the method 1310 of FIG. 13 may help reduce computational cost by providing approximate values in regions or portions of regions that tend to be flatter or include dips with low dip angles (e.g., according to a dip angle limit, which may be adjustable).

The method 1310 is shown in FIG. 13 in association with various computer-readable media (CRM) blocks 1313, 1315, 1317, 1319, and 1321. Such blocks generally include instructions suitable for execution by one or more processors (or cores) to instruct a computing device or system to perform one or more actions. While various blocks are shown, a single medium may be configured with instructions to allow for, at least in part, performance of various actions of the method 1310. As an example, a computer-readable medium (CRM) may be a computer-readable storage medium.

Table 1, below, shows some examples of trial results from running various approaches on a 3 GB 32-bit seismic cube with the same parameters. The execution times where measured for 5 computations of the whole cube. The mean computational time is presented in Table 1. Given these results, a hybrid dip approach (see, e.g., the method 1310 of FIG. 13) can reduce computation demands while providing detailed images.

TABLE 1
Trial Execution Times.

| Method | Execution time |
|---|---|
| Dip Scan* | 28 min 50 sec |
| Gradient tensor (Principal component) | 4 min 35 sec |
| Hybrid (event and dip scan) | 3 min 31 sec |

*a dip scan approach as in diagram 430 of FIG. 4.

The example trial results of Table 1 indicate that a hybrid approach can provide dip values in a reasonable amount of time, suitable for an interpretation session where various parameters may be adjusted and the approach repeated (e.g., optionally as a background process).

The images of FIGS. 10, 11 and 12 correspond to a data set from the Gulf of Mexico. The data includes indicia of varying types of dipping features, where some of the areas are flat, while others have steeper dip. Geologically, these features stem from several salt diapirs that are pushing their way up through the structure and creating steep dipping layers around them. The data set also includes indicia of some discontinuities and faulting structural features, for example, due to the structural stress fields induced by the movement of the salt bodies.

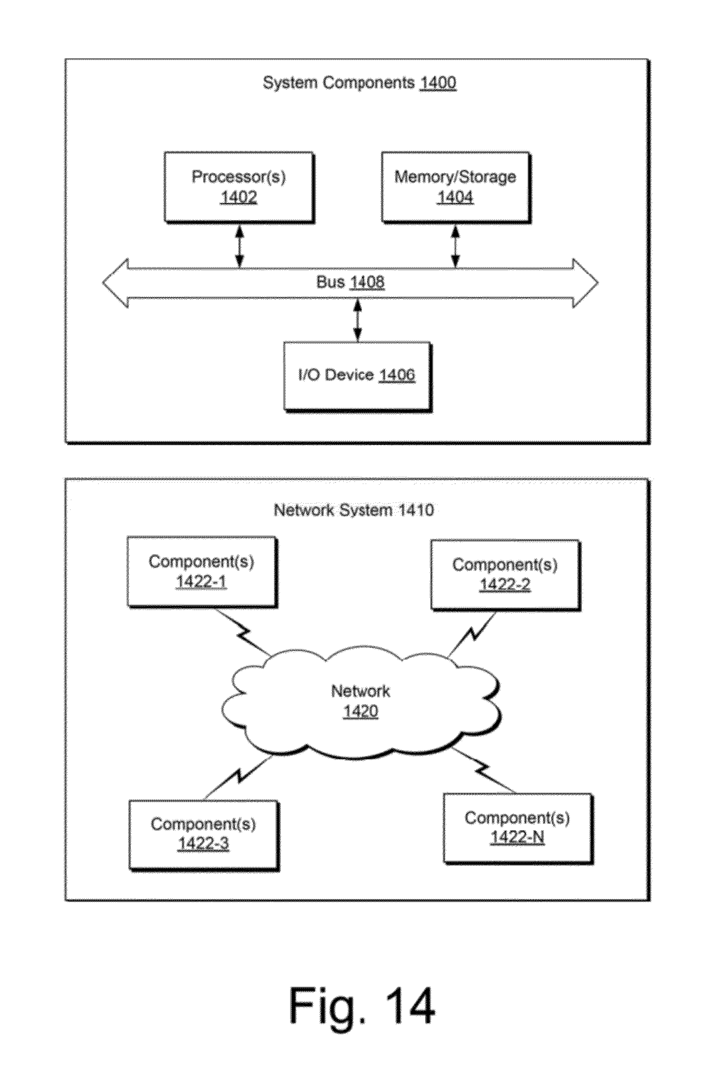

FIG. 14 shows components of an example of a computing system 1400 and an example of a networked system 1410. The system 1400 includes one or more processors 1402, memory and/or storage components 1404, one or more input and/or output devices 1406 and a bus 1408. In an example embodiment, instructions may be stored in one or more computer-readable media (e.g., memory/storage components 1404). Such instructions may be read by one or more processors (e.g., the processor(s) 1402) via a communication bus (e.g., the bus 1408), which may be wired or wireless. The one or more processors may execute such instructions to implement (wholly or in part) one or more attributes (e.g., as part of a method). A user may view output from and interact with a process via an I/O device (e.g., the device 1406). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1410. The network system 1410 includes components 1422-1, 1422-2, 1422-3, . . . 1422-N. For example, the components 1422-1 may include the processor(s) 1402 while the component(s) 1422-3 may include memory accessible by the processor(s) 1402. Further, the component(s) 1402-2 may include an I/O device for display and optionally interaction with a method. The network may be or include the Internet, an intranet, a cellular network, a satellite network, etc.

Although a few example embodiments have been described in detail above, those skilled in the art will readily appreciate that many modifications are possible in the example embodiments without materially departing from the embodiments of the present disclosure. Accordingly, such modifications are intended to be included within the scope of this disclosure as defined in the following claims. In the claims, means-plus-function clauses are intended to cover the structures described herein as performing the recited function and not just structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

1. A method comprising:
providing a neighborhood of seismic traces along inline and crossline directions;
within the neighborhood, selecting a sample seismic trace and neighboring seismic traces;
individually time shifting each of the neighboring seismic traces with respect to the sample seismic trace to determine a set of individual time shift values that correspond to individual maximum cross correlation values for each of the neighboring seismic traces with respect to the sample seismic trace;
determining a series of inline direction first derivative values for the set of time shift values;
determining a series of crossline direction first derivative values for the set of time shift values;
determining an inline average dip value based on the series of inline first derivative values;
determining a crossline average dip value based on the series of crossline first derivative values; and
storing to a memory storage device, coordinates for the sample seismic trace, the inline average dip value, and the crossline average dip value.

2. The method of claim 1 further comprising accessing previously stored inline average dip values and crossline average dip values for other sample seismic traces, processing the average dip values for the sample seismic trace and the other seismic sample traces and rendering to a display an image based at least in part on the processing.

3. The method of claim 2 further comprising identifying in the image at least one member selected from a group consisting of faults, channels, and salt bodies.

4. The method of claim 2 further comprising identifying at least one salt dome in the image.

5. The method of claim 2 wherein the processing comprises directional processing of the average dip values along an angle between the inline direction and the crossline direction.

6. The method of claim 5 wherein the processing comprises use of an Euler equation.

7. The method of claim 2 wherein the processing comprises direction muting.

8. The method of claim 1 further comprising commencing the method responsive to receipt of an instruction input via a graphical user interface that comprises an attribute menu.

9. The method of claim 1 wherein the individually time shifting each of the neighboring seismic traces with respect to the sample seismic trace to determine a set of individual time shift values that correspond to individual maximum cross correlation values for each of the neighboring seismic traces with respect to the sample seismic trace comprises:
for each of the neighboring seismic traces, determining a cross correlation value for a positive time shift value, a cross correlation value for a negative time shift value and a cross correlation value for a zero time shift value;
comparing the cross correlation values;
based on the comparing, determining additional cross correlation values for either greater positive time shift values or greater negative time shift values until a decrease occurs in one of the cross correlation values; and
responsive to the decrease, assigning a time shift value that corresponds to a maximum cross correlation value.

10. A system comprising:
one or more processors;
memory; and
instructions stored in the memory and executable by at least one of the one or more processors to
access seismic traces,
determine time shift values for pairs of the seismic traces wherein a time shift value for a pair of seismic traces corresponds to a maximum cross correlation value for the pair,
process the time shift values to provide dip angle values, and
render to a display an image based at least in part on the dip angle values.

11. The system of claim 10 wherein the instructions to determine time shift values for pairs of the seismic traces comprise instructions to shift one seismic trace of the pair with respect to the other seismic trace of the pair.

12. The system of claim 10 wherein the instructions to process the time shift values comprise instructions to determine slopes based on the time shift values.

13. The system of claim 10 wherein the instructions to process the time shift values comprise instructions to provide directional dip angle values.

14. The system of claim 10 wherein the instructions to process the time shift values comprise instructions to provide dip angle magnitude values.

15. The system of claim 10 further comprising a display and instructions to render a graphical user interface to the display for input to adjust one or more parameters associated with the instructions to process the time shift values.

16. One or more computer-readable storage media comprising computer-executable instructions to instruct a computing device to:
access weighted average inline dip angle values and weighted average crossline dip angle values;
select an algorithm from a group of algorithms that comprises a dip magnitude algorithm and a directional dip algorithm; and
apply the selected algorithm to the weighted average inline dip angle values and the weighted average crossline dip angle values to generate image data.

17. The one or more computer-readable storage media of claim 16 further comprising computer-executable instructions to instruct a computing device to:
render an image to a display based on the generated image data.

18. The one or more computer-readable storage media of claim 16 wherein the directional dip algorithm comprises the following equation:
DirectionDip=InlineDip*sin Θ+XlineDip*cos Θ
wherein InlineDip represents a weighted average inline dip angle value, XlineDip represents a weighted average crossline dip angle value and where Θ represents a directional angle.

19. The one or more computer-readable storage media of claim 16 wherein the dip magnitude algorithm comprises the following equation:
$$DipMag = \frac{{InlineDip}^{2} + {XlineDip}^{2}}{\sqrt{{InlineDip}^{2} + {XlineDip}^{2}}}$$
wherein InlineDip represents a weighted average inline dip angle value and XlineDip represents a weighted average crossline dip angle value.

20. The one or more computer-readable storage media of claim 16 wherein the dip magnitude algorithm comprises the following equation:
DipMag=\sqrt{InlineDip²+XlineDip²}
wherein InlineDip represents a weighted average inline dip angle value and XlineDip represents a weighted average crossline dip angle value.
